(19) United States
(12) Patent Application Publication
(10) Pub. No.: US 2015/0310768 A1
(43) Pub. Date: Oct. 29, 2015

(54) SYSTEMS AND METHODS FOR THYROID SURGERY SIMULATION

(71) Applicants: MedStar Health, Inc., Columbia, MD (US); SimSkin, Chicago, IL (US)

(72) Inventors: Erin A. Felger, Falls Church, VA (US); Aidan Boswick, Melville, NY (US); Matthew Dotson, Chicago, IL (US)

(21) Appl. No.: 14/695,457

(22) Filed: Apr. 24, 2015

Related U.S. Application Data
(60) Provisional application No. 61/985,717, filed on Apr. 29, 2014.

(51) Int. Cl. G09B 23/34

(52) U.S. Cl. CPC G09B 23/34

(57) ABSTRACT

One aspect of the present disclosure relates to a device for simulating a thyroid surgical procedure. The device can include a removable neck model configured to be accepted into a body model. The removable neck model can include a thyroid model that includes a first lobe and a second lobe connected by an isthmus, at least four parathyroid gland models arranged posterior to the thyroid model and spread between the lobes, and a nerve model. The nerve model can include a first superior laryngeal nerve model arranged medial and posterior to the first lobe, a second superior laryngeal nerve model arranged medial and posterior to the second lobe, a first recurrent laryngeal nerve model arranged medial and posterior to the first lobe, and a second recurrent laryngeal nerve model arranged medial and posterior to the second lobe.

### RELATED APPLICATIONS

This application claims the benefit of U.S. Provisional Application No. 61/985,717, filed Apr. 29, 2014, entitled “SYSTEMS AND METHODS FOR THYROID SURGERY SIMULATION.” This application is also related to U.S. Design Application No. 29/489,320, filed Apr. 29, 2014, now patented. The entirety of these provisional applications is hereby incorporated by reference for all purposes.

### FIELD OF THE INVENTION

The present disclosure relates generally to systems and methods for surgical training and, more particularly, to systems and methods for thyroid surgery simulation.

### BACKGROUND OF THE INVENTION

By the end of a five-year clinical residency, general surgery residents must show competency and technical skill in a variety of areas that encompass the fundamental body of surgical care (e.g., outlined in the Surgical Council on Residency Education (SCORE) Patient Care Curriculum). In theory, most general surgery residents should be able to acquire the required competency and technical skill in most of these areas through exposure to these areas during their residency. However, the Accreditation Council for Graduate Medical Education (ACGME) and other regulatory bodies have limited general surgery residents to an eighty-hour workweek. The limited workweek often limits the general surgery residents' exposure to one or more of the areas that encompass the fundamental body of surgical care, including thyroid surgeries (e.g., thyroid lobectomy). General surgery residents may not exhibit the required competency and technical skill related to areas with limited exposure.

### SUMMARY OF THE INVENTION

The present disclosure relates generally to surgical training and, more particularly, to systems and methods for thyroid surgery simulation. For example, the thyroid surgical simulation can employ a device for simulating a thyroid surgical procedure to increase surgical proficiency for thyroid and parathyroid surgeries.

In one aspect, the present disclosure can include device for simulating at least one thyroid surgical procedure that includes a removable neck model that can be configured to be accepted into a body model. The removable neck model can include a thyroid model comprising a first lobe and a second lobe connected by an isthmus, at least two first parathyroid gland models arranged posterior to the first lobe, at least two second parathyroid gland models arranged posterior to the second lobe, and a nerve model comprising a first superior laryngeal nerve model arranged medial and posterior to the first lobe, a second superior laryngeal nerve model arranged medial and posterior to the second lobe, a first recurrent laryngeal nerve model arranged medial and posterior to the first lobe, and a second recurrent laryngeal nerve model arranged medial and posterior to the second lobe.

In another aspect, the present disclosure can include a method of training for a surgical procedure. A device for simulating a plurality of thyroid surgical procedures, configurable for at least two surgical procedures, can be presented. One of the surgical procedures can be selected, and the device can be modified for the selected surgical procedure. The selected surgical procedure can be simulated on the modified device.

In a further aspect, the present disclosure can include method for improving surgical competency. One of a plurality of surgical procedures can be selected, and a device configurable for the plurality of surgical procedures can be configured for the selected surgical procedure. Instructions associated with the selected surgical procedure can be played by a playback device that includes a processor. The selected surgical procedure can be performed using the device according to the instructions.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic block diagram showing a front view of an example of a removable neck model in accordance with an aspect of the present disclosure;

FIG. 2 is a schematic block diagram showing a back view of the example of the removable neck model in FIG. 1;

FIG. 3 is an illustration of an example of a system including the removable neck model in FIG. 1 with additional components laid in a body model;

FIG. 4 is a photograph depicting another example of a system including the removable neck model in FIG. 1 with additional components laid in a body model;

FIG. 5 is a schematic diagram showing a front perspective view of the removable neck model in FIG. 3;

FIG. 6 is a schematic diagram showing a back view of the removable neck model in FIG. 3;

FIG. 7 is a schematic block diagram showing a system that can be used to simulate at least one thyroid surgical procedure in an educational setting in accordance with an aspect of the present disclosure;

FIG. 8 is a process flow diagram illustrating a method for training for a surgical procedure in accordance with an aspect of the present disclosure;

FIG. 9 is a process flow diagram illustrating a method for improving surgical competency in accordance with an aspect of the present disclosure; and

FIG. 10 is a process flow diagram illustrating a method for assessing a medical professional's competency at a thyroid surgical procedure in accordance with an aspect of the present disclosure.

### DETAILED DESCRIPTION OF THE INVENTION

### I. Definitions

In the context of the present disclosure, the singular forms “a,” “an” and “the” can also include the plural forms, unless the context clearly indicates otherwise.

The terms “comprises” and/or “comprising,” as used herein, can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “surgical trainer” can refer to a device (e.g., a model) that can be used to simulate one or more surgical procedures. The surgical trainer can be used by a surgeon, a surgical resident, a surgeon, a nurse, a nursing student, or other medical professional to increase competency and technical skill in a surgical procedure. A surgical trainer can also be used to simulate a surgical procedure for a patient. The terms “surgical trainer,” “training model,” and “device for simulating a surgical procedure” can be used interchangeably herein.

As used herein, the term “simulation” can refer to an imitation, reproduction, or approximation of surgical conditions. An example simulation can use a surgical trainer to approximate a thyroid surgical procedure.

As used herein, the term “thyroid surgical procedure” can refer to a surgical procedure involving the thyroid gland and/or the parathyroid gland. Examples of thyroid surgical procedures can include: a thyroidectomy, a goiter surgery, a thyroid cancer surgery, a surgery for Grave's Disease, and a parathyroidectomy.

As used herein, the term “model” can refer to a representation of a portion of a patient to be used in a simulation of an actual surgical procedure.

As used herein, the term “medical professional” can refer to any person involved the conducting a surgical procedure that can be simulated by the surgical trainer, including, but not limited to, physicians, residents, medical students, nurse practitioners, nurses, nursing students, and other operating room staff.

As used herein, the term “patient” can refer to any warm-blooded organism including, but not limited to, a human being, a pig, a rat, a mouse, a dog, a cat, a goat, a sheep, a horse, a monkey, an ape, a rabbit, a cow, etc.

### II. Overview

The present disclosure relates generally to surgical training and, more particularly, to systems and methods for thyroid surgery simulation. The systems and methods described herein can employ a device for simulating a thyroid surgical procedure (e.g., employing a removable neck model) to increase surgical proficiency for thyroid and parathyroid surgeries. In some instances, the device described herein can allow a general surgery resident to acquire the required competency and technical skills for thyroid and parathyroid surgeries within their limited eighty-hour workweek. The device can be used in simulations that replicate actual surgical conditions, allowing general surgery residents to be exposed to these thyroid and parathyroid surgeries.

### III. Systems

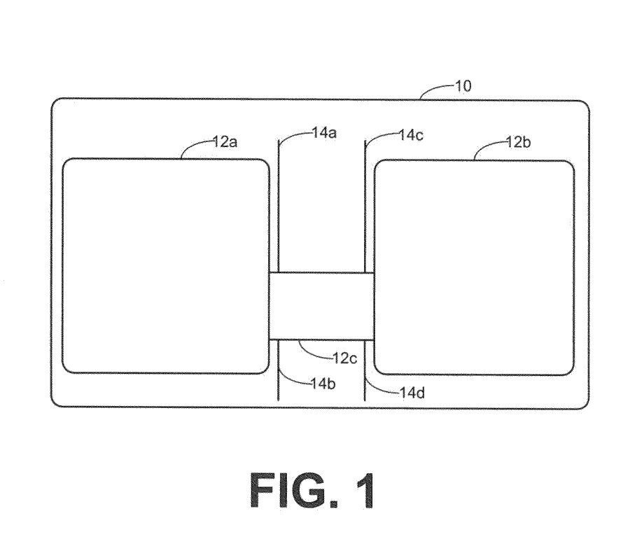

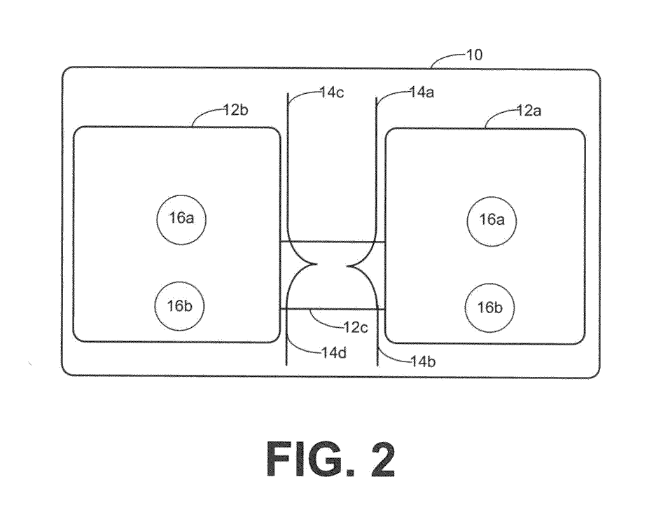

One aspect of the present disclosure can include a device for simulating at least one thyroid surgical procedure. An schematic example of a removable neck model 10 that can be removed from a device (e.g., a model of at least a portion of the patient's body including the neck) for simulating at least one thyroid surgical procedure is shown in FIG. 1 (front view) and FIG. 2 (back view). For example, the removable neck model 10 can include components that can be added, removed, or altered for the different surgical procedures. The block diagrams of FIGS. 1-2 are not intended to constrain the shape and/or size of the components.

FIGS. 1 and 2 show a front view and a back view of a removable neck model 10 that can be used in a device for simulating at least one thyroid surgical procedure. The removable neck model can include a thyroid model that includes a first lobe 12a and a second lobe 12b that are connected by an isthmus 12c. Posterior to the thyroid model, the removable neck model 10 can include a number of parathyroid gland models. The parathyroid gland models can be arranged on the surface of the thyroid model and/or in proximity to the thyroid model. In some instances, the removable neck model 10 can include at least four parathyroid gland models. On the posterior of the first lobe 12a, the removable neck model can include at least two first parathyroid gland models 16a, 16b. On the posterior of the second lobe 12b, the removable neck model can include at least two second parathyroid gland models 16c, 16d. However, the removable neck model 10 can include a different number of parathyroid gland models. Additionally, the parathyroid gland models 16a-d can be added, removed, and/or altered in position in the removable neck model 10.

The removable neck model 10 can also include a nerve model that can include nerves in the neck anatomically close to the thyroid gland. For example, the nerve model can include a first superior laryngeal nerve model 14a arranged medial and posterior to the first lobe 12a, a second superior laryngeal nerve model 14c arranged medial and posterior to the second lobe 12b, a first recurrent laryngeal nerve model 14b arranged medial and posterior to the first lobe 12a, and a second recurrent laryngeal nerve model 14d arranged medial and posterior to the second lobe 12b. In some instances, the removable neck model 10 can include more nerves that innervate other areas of the neck. In other instances, the nerves can be removable and/or able to alter positions.

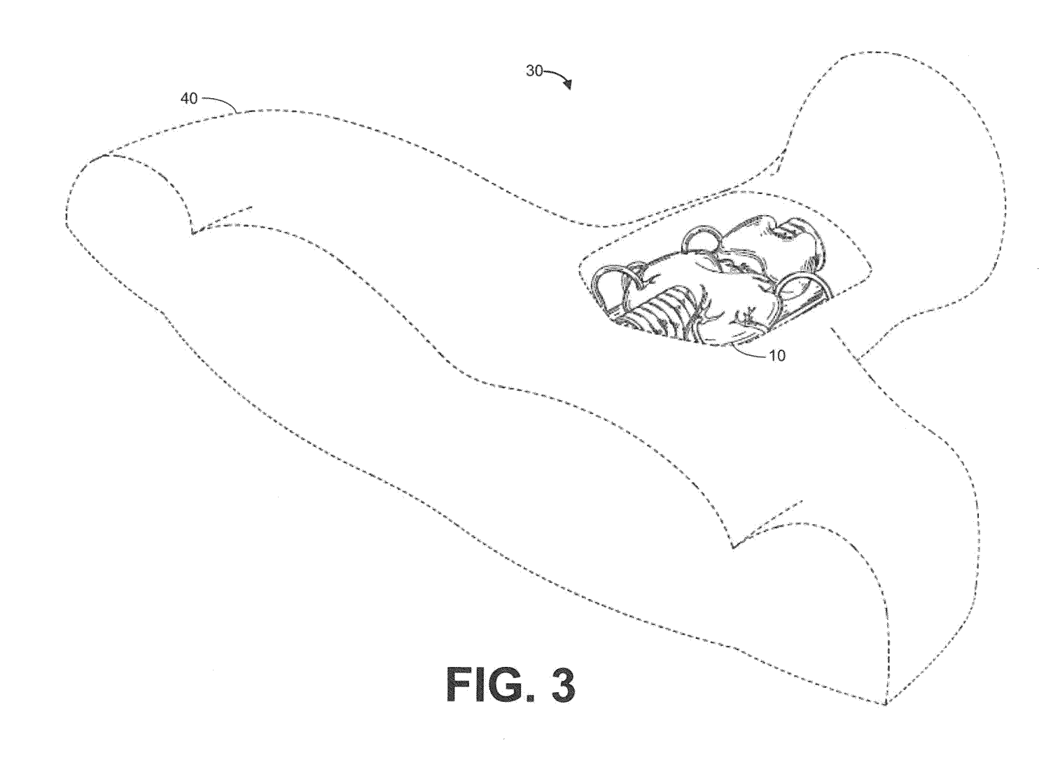

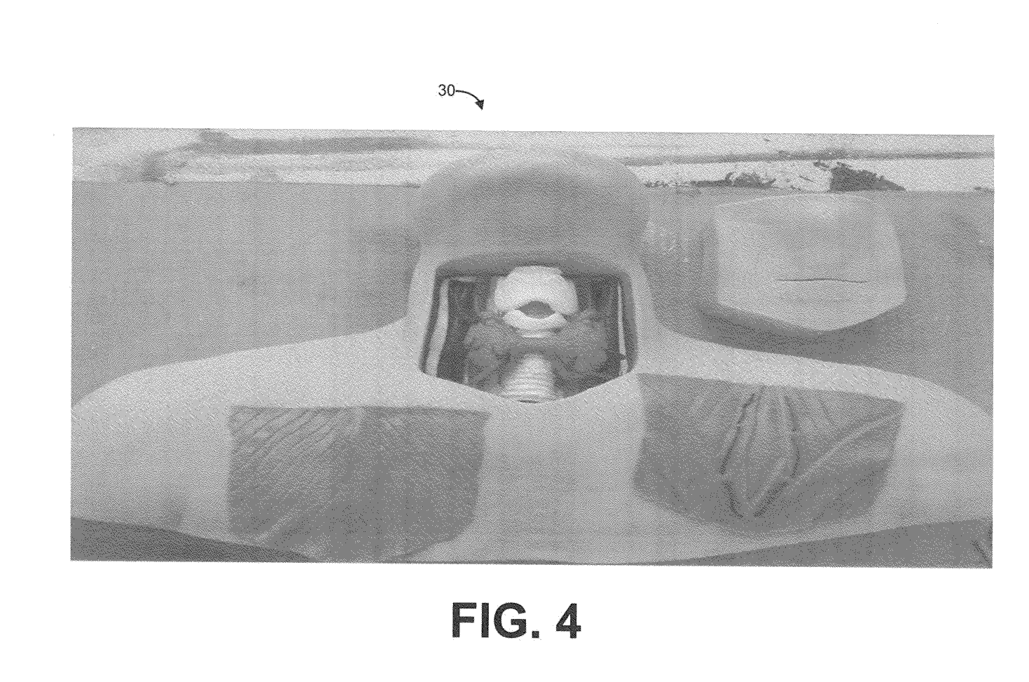

FIGS. 3 and 4 show different illustrations 30 of systems where the removable neck model 10 placed inside a body model 20. For example, in some instances the removable neck model 10 can be configured to be accepted into the body model 20 and removed from the body model. In other instances, the removable neck model 10 can be located at least semi-permanently within the body model 20. Additionally, although many potential additional features of the removable thyroid model 10 are shown in FIGS. 3 and 4, none, some, or all of the features can be included in different instances of the removable neck model 10.

The body model 20 can include a chin model, a chest model, and a stationary neck model arranged between the chin model and the chest model. The stationary neck model can be configured to receive the removable neck model. In some instances, the stationary neck model can be configured to receive the removable neck model while impeded by the chin model. The impedance of the stationary neck model by the chin model emulates actual surgical conditions where a patient has a chin that can impede thyroid surgery. For example, the stationary neck model can have a length from about 10 cm to about 25 cm, and the chin model can extend over the stationary neck model for a length from about 3 cm to about 10 cm.

Another feature of the body model that can emulate actual surgical conditions is a skin model surrounding at least part of the chin model, the chest model, and the stationary neck model. Additionally, the chest model, the stationary neck model, and/or the chin model can include a muscle model and/or a connective tissue model that can further emulate actual surgical conditions. Furthermore, the stationary neck model can be covered with a removable portion to emulate the insertions that should be made during a thyroid surgical procedures.

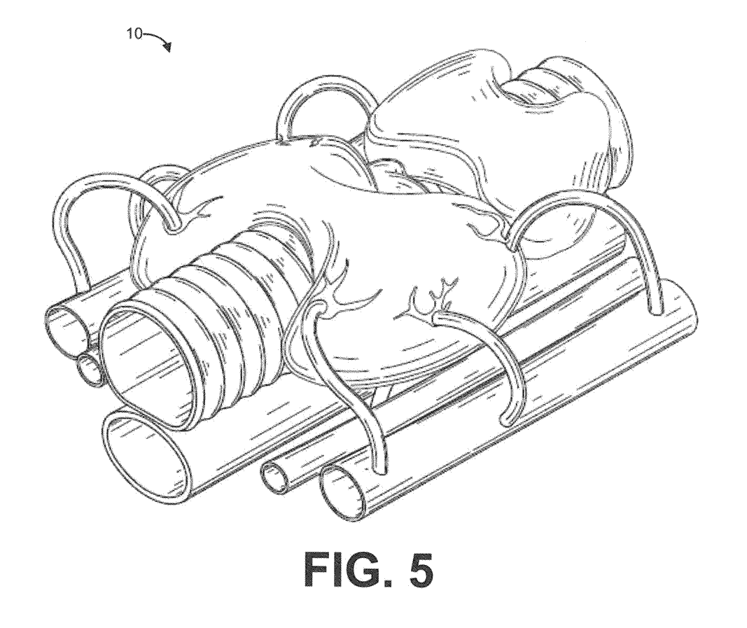

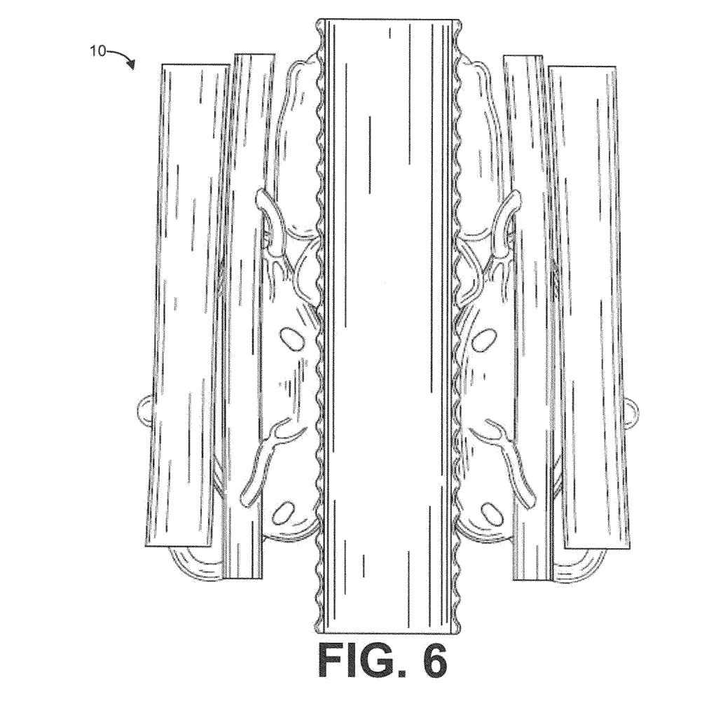

As shown in FIG. 5 and FIG. 6, the removable neck model 10 can include models of additional anatomical features of the neck. Although all of the possible additional features are shown in FIGS. 5-6, none, some, or all of the additional features can be included in different instances of the removable neck model 10. In some instances, other features can be added to the FIGS. 5-6.

In some instances, the removable neck model 10 can include a trachea model arranged posterior to the isthmus 12c of the thyroid model. The first lobe 12a and the second lobe 12b of the thyroid model can surround the trachea model. The removable neck model can also include a cartilage model superior to the thyroid model that includes at least a thyroid cartilage model surrounding the trachea, and a cricoid cartilage model surrounding the trachea arranged inferior to the thyroid cartilage model. The removable neck model 10 can also include an esophagus model arranged posterior to the trachea model. The first lobe 12a and the second lobe 12b of the thyroid model can extend posteriorly reaching the esophagus model.

In other instances, the removable neck model 10 can include a blood vessel model that can include an arterial model that interfaces with the first lobe 12a and the second lobe 12b of the thyroid model and a vascular model that interfaces with the first lobe 12a and the second lobe 12b of the thyroid model. The arterial model can include one or more of: a superior thyroid artery model, a common carotid artery model, and/or an inferior thyroid artery model. The venous model can include one or more of: a superior thyroid vein model, an internal jugular vein model, and/or a middle thyroid vein model.

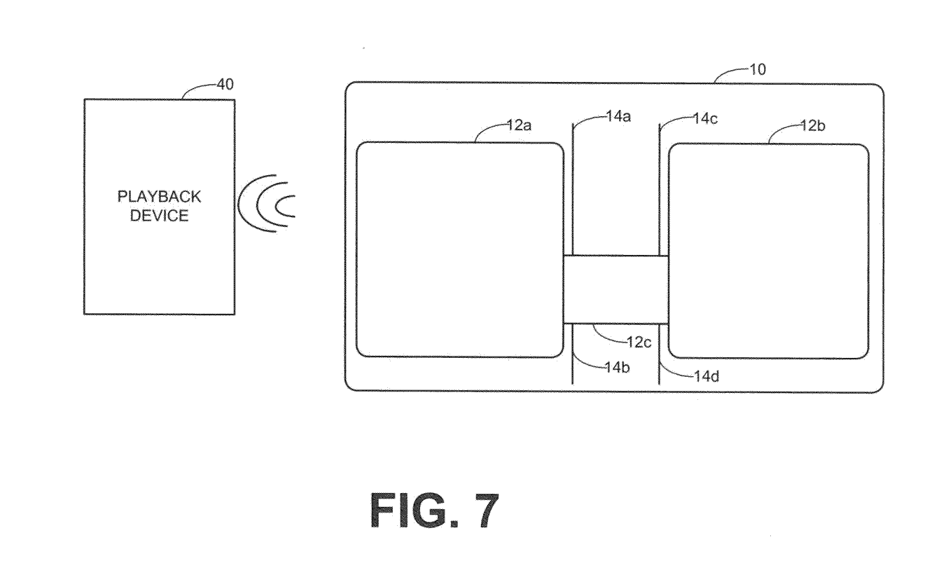

FIG. 7 shows a system that can be used to simulate at least one thyroid surgical procedure in an educational setting. The system includes the removable neck model 10 that can be used to simulate a thyroid surgical procedure. The system also includes a playback device 40 that can display instructions (e.g., audio instructions, video instructions, printed instructions) associated with the one of the at least one surgical procedure.

FIG. 7 is illustrated schematically as block diagrams of systems with the different blocks representing different components. The functions the playback device 40 can be implemented by computer program instructions. These computer program instructions can be stored in a non-transitory memory and provided to a processor of a general purpose computer, special purpose computer, and/or other programmable data processing apparatus to produce a machine, such that the instructions, which execute via the processor of the computer and/or other programmable data processing apparatus, create a mechanism for implementing the functions of the components specified in the block diagrams. For example, the functionality of the playback device 40 can be implemented by computer program instructions that can be stored in a non-transitory memory and provided to a processor for execution to implement the functions of the playback device 40.

In some instances the removable neck model 10 can be configurable for a plurality of different thyroid surgical procedures. The playback device 40 can store instructions for the plurality of different thyroid surgical procedures, and allow a user to select the instructions one of the plurality of different thyroid surgical procedures (e.g., by presenting options corresponding to the various instructions in a menu) for playback. The selected instructions can be played back by the playback device 40 so that the user can simulate the selected thyroid surgical procedure using the removable neck model 10 according to the instructions.

### IV. Methods

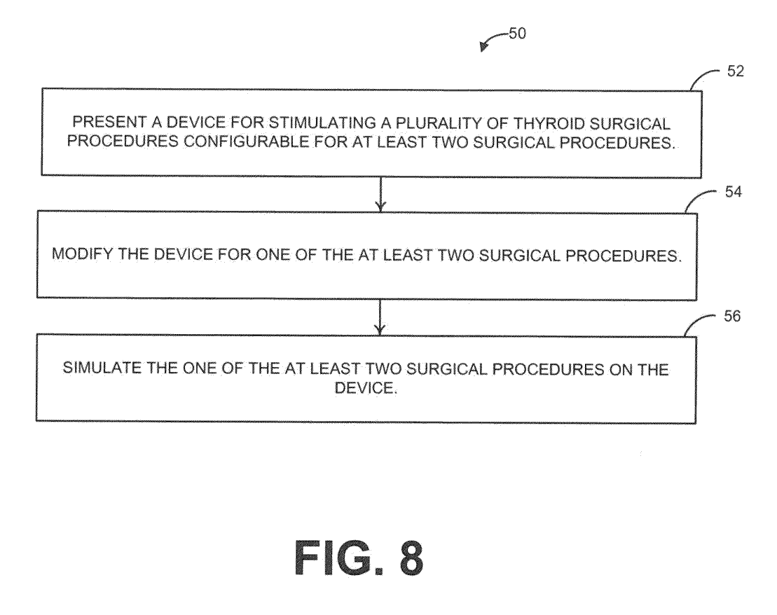

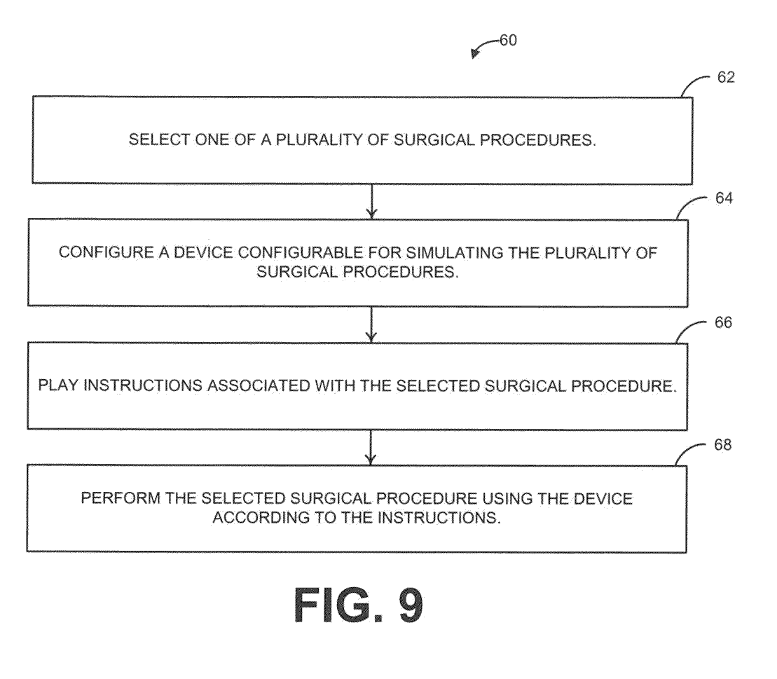

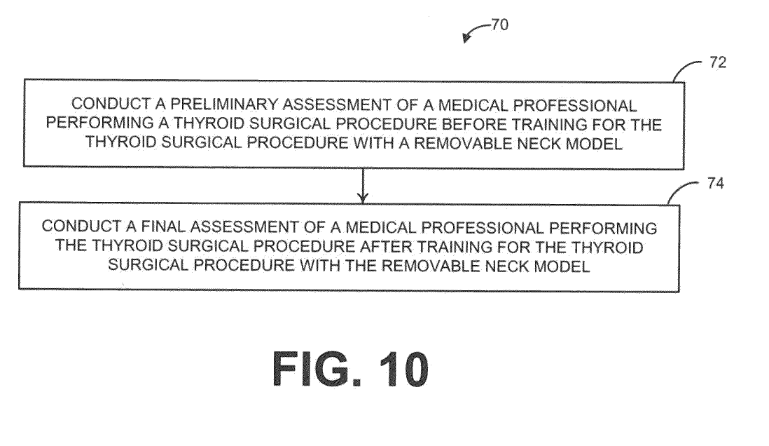

A second aspect of the present disclosure can include methods that can employ a device for simulating at least one thyroid surgical procedure. An example of a method 50 for training for a surgical procedure is shown in FIG. 8. Another example of a method 60 for improving surgical competency is shown in FIG. 9. A further example of a method 70 for assessing a medical professional's competency at performing a thyroid surgical procedure is shown in FIG. 10.

The methods 50, 60, and 70 are illustrated as process flow diagrams with flowchart illustrations. For purposes of simplicity of explanation, the methods 50, 60, and 70 are shown and described as executing serially, it is to be understood and appreciated that the present disclosure is not limited by the illustrated order, as some aspects could occur in different orders and/or concurrently with other aspects shown and described herein. Moreover, not all illustrated aspects may be required to implement methods 50, 60, and/or 70.

In some instances, one or more blocks of the respective flowchart illustrations, and combinations of blocks in the block flowchart illustrations, can be implemented by computer program instructions. These computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, some of the steps/acts can be implemented by a system comprising a processor that can access the computer-executable instructions that are stored in a non-transitory memory.

FIG. 8 depicts a method 50 for training for a surgical procedure. At element 52, a device for stimulating a plurality of thyroid surgical procedures (e.g., removable neck model 10) can be presented. The device can be configurable for at least two thyroid surgical procedures (e.g., two or more of a thyroidectomy, a goiter surgery, a thyroid cancer surgery, a surgery for Grave's Disease, and/or a parathyroidectomy). At element 54, the device can be modified for one of the at least two thyroid surgical procedures. At element 56, at least one of the thyroid surgical procedures can be stimulated on the device. The simulation can be assisted by playing (e.g., by playback device 40) instructions associated with the at least one of the thyroid surgical procedures.

In some instances, method 50 can be used in the training (e.g., of a medical professional) for the selected surgical procedure. The selected surgical procedure can be performed on a first patient before the selected surgical procedure is performed using the device and on a second patient after the selected surgical procedure is performed using the device. The procedure can be performed on the second patient with a greater proficiency than the procedure is performed on the first patient.

FIG. 9 depicts a method 60 for improving surgical competency. At element 62, one of a plurality of surgical procedures (e.g., the plurality of surgical procedures can include at least two of a thyroidectomy, a goiter surgery, a thyroid cancer surgery, a surgery for Grave's Disease, and a parathyroidectomy) can be selected (e.g., from a menu displayed by playback device 40). At element 64, a device (e.g., removable neck model 10) configurable for simulating the plurality of surgical procedures is configured for the selected surgical procedure. For example, components of the device can be added and/or removed based on the selected surgical procedure.

At element 66, instructions associated with the selected surgical procedure can be played (e.g., by playback device 40). In some instances, the instructions can be displayed visually. In other instances, the instructions can be played audibly. At element 68, the selected surgical procedure can be performed (e.g., in response to the instructions) using the device according to the instructions. In some instances, the selected surgical procedure can be performed on a first patient before the selected surgical procedure is performed using the device and on a second patient after the selected surgical procedure is performed using the device. The procedure can be performed on the second patient with a greater proficiency than the procedure is performed on the first patient.

FIG. 10 depicts a method 70 for assessing surgical competency. At element 72, a preliminary assessment of a medical professional's competency performing a thyroid surgical procedure can be conducted before the medical professional trains for the surgical procedure using a removable neck model (e.g., removable neck model 10). At element 74, a final assessment of the medical professional's competency can be conducted after the medical professional trains for the surgical procedure using the removable neck model.

For example, a scoring rubric that can be used to assess the surgical competence of a medical professional (e.g., a general surgery resident). The assessment can be conducted before training with the removable neck model 10 and after training with removable neck model 10. Generally, after the training with removable neck model 10, the medical professional will exhibit a higher score according to the scoring rubric. In some instances, the training can include one or more surgical simulations on the removable neck model 10. In other instances, the training can include two or more surgical simulations on the removable neck model 10. In still other instances, the training can include three or more surgical simulations on the removable neck model 10. For example, after the training, the medical professional can perform the surgical procedure with a greater competency.

From the above description, those skilled in the art will perceive improvements, changes and modifications. Such improvements, changes and modifications are within the skill of one in the art and are intended to be covered by the appended claims.

What is claimed is:

1. A device for simulating at least one thyroid surgical procedure, the device comprising:
a removable neck model configured to be accepted into a body model, the removable neck model comprising:
a thyroid model comprising a first lobe and a second lobe connected by an isthmus;
at least two first parathyroid gland models arranged posterior to the first lobe;
at least two second parathyroid gland models arranged posterior to the second lobe; and
a nerve model comprising a first superior laryngeal nerve model arranged medial and posterior to the first lobe, a second superior laryngeal nerve model arranged medial and posterior to the second lobe, a first recurrent laryngeal nerve model arranged medial and posterior to the first lobe, and a second recurrent laryngeal nerve model arranged medial and posterior to the second lobe.

2. The device of claim 1, further comprising:
the body model comprising:
a chin model;
a chest model; and
a stationary neck model arranged between the chin model and the chest model and configured to receive the removable neck model while impeded by the chin model; and
a skin model covering at least a portion of the body model.

3. The device of claim 2, wherein at least one of the chest model, the stationary neck model, and the chin model comprises at least one of a muscle model and a connective tissue model.

4. The device of claim 2, wherein the stationary neck model has a length from about 10 cm to about 25 cm,
wherein the chin model extends over the stationary neck model for a length from about 3 cm to about 10 cm.

5. The device of claim 1, wherein the removable neck model further comprises a trachea model arranged posterior to the isthmus of the thyroid model,
wherein the first lobe of the thyroid model and the second lobe of the thyroid model surround the trachea model.

6. The device of claim 5, wherein the removable neck model further comprises a cartilage model, comprising:
a thyroid cartilage model surrounding the trachea; and
a cricoid cartilage model surrounding the trachea arranged inferior to the thyroid cartilage model and superior to the thyroid model.

7. The device of claim 5, wherein the removable neck model further comprises an esophagus model arranged posterior to the trachea model,
wherein the first lobe and the second lobe of the thyroid model extend posteriorly reaching the esophagus model.

8. The device of claim 1, wherein the removable neck model further comprises a blood vessel model comprising an arterial model that interfaces with the first lobe and the second lobe of the thyroid model and a vascular model that interfaces with the first lobe and the second lobe of the thyroid model.

9. A method for surgical training, comprising:
presenting a device for simulating a thyroid surgical procedure, wherein the device is configurable for simulating at least two surgical procedures;
modifying a configuration of the device for one of the at least two surgical procedures; and
simulating the one of the at least two surgical procedures on the device.

10. The method of claim 9, wherein the device comprises:
a removable neck model configured to be accepted into a body model, comprising:
a thyroid model comprising a first lobe and a second lobe connected by an isthmus;
at least two first parathyroid gland models arranged posterior to the first lobe;
at least two second parathyroid gland models arranged posterior to the second lobe; and
a nerve model comprising a first superior laryngeal nerve model arranged medial and posterior to the first lobe, a second superior laryngeal nerve model arranged medial and posterior to the second lobe, a first recurrent laryngeal nerve model arranged medial and posterior to the first lobe, and a second recurrent laryngeal nerve model arranged medial and posterior to the second lobe.

11. The method of claim 10, wherein the device further comprises the body model,
wherein the body model comprises:
a chin model;
a chest model; and
a stationary neck model arranged between the chin model and the chest model and configured to receive the removable neck model while impeded by the chin model, and
wherein at least a portion of the body model is covered by a skin model.

12. The method of claim 9, wherein the at least two surgical procedures comprise at least two of a thyroidectomy, a goiter surgery, a thyroid cancer surgery, a surgery for Grave's Disease, and a parathyroidectomy.

13. The method of claim 9, further comprising playing, from a playback device comprising a processor, instructions associated with the one of the at least two surgical procedures

14. The method of claim 9, further comprising:
performing the one of the at least two surgical procedures on a first patient before the selected surgical procedure is performed using the device; and
performing the one of the at least two surgical procedures on a second patient after the one of the at least two surgical procedures is performed using the device,
wherein the one of the at least two surgical procedures is performed on the second patient with a greater proficiency than the one of the at least two surgical procedures is performed on the first patient.

15. A method for improving surgical competency, comprising:
selecting one of a plurality of surgical procedures;
configuring a device configurable for simulating the plurality of surgical procedures for the selected surgical procedure;
playing, from a playback device comprising a processor, instructions associated with the selected surgical procedure; and
performing the selected surgical procedure using the device according to the instructions.

16. The method of claim 15, further comprising:
performing the selected surgical procedure on a first patient before the selected surgical procedure is performed using the device; and
performing the selected surgical procedure on a second patient after the selected surgical procedure is performed using the device,
wherein the selected surgical procedure is performed with a greater proficiency than the first surgical procedure.

17. The method of claim 15, wherein the plurality of surgical procedures comprises at least two of a thyroidectomy, a goiter surgery, a thyroid cancer surgery, a surgery for Grave's Disease, and a parathyroidectomy.

18. The method of claim 15, wherein the device comprises a removable neck model configured to be accepted into a body model, comprising
a thyroid model comprising a first lobe and a second lobe connected by an isthmus;
at least two first parathyroid gland models arranged posterior to the first lobe;
at least two second parathyroid gland models arranged posterior to the second lobe; and
a nerve model comprising a first superior laryngeal nerve model arranged medial and posterior to the first lobe, a second superior laryngeal nerve model arranged medial and posterior to the second lobe, a first recurrent laryngeal nerve model arranged medial and posterior to the first lobe, and a second recurrent laryngeal nerve model arranged medial and posterior to the second lobe.

19. The method of claim 18, wherein the device further comprises the body model,
wherein the body model comprises:
a chin model;
a chest model; and
a stationary neck model arranged between the chin model and the chest model and configured to receive the removable neck model while impeded by the chin model, and
wherein the at least a portion of the body model is covered by a skin model.

20. The method of claim 19, wherein the stationary neck model has a length from about 10 cm to about 25 cm,
wherein the chin model extends over the stationary neck model for a length from about 3 cm to about 10 cm.
